(19) United States
(12) Patent Application Publication
(10) Pub. No.: US 2025/0096699 A1
(43) Pub. Date: Mar. 20, 2025

(54) Techniques for Power Conversion in Single-Phase and Multi-Phase Power Networks

(71) Applicant: Huawei Digital Power Technologies Co., Ltd., Shenzhen (CN)

(72) Inventors: Daniel Gaona, Nuremberg (DE); Lucia Clavero Ordonez, Nuremberg (DE); Piniwan Thiwanka Bandara Wijekoon, Nuremberg (DE)

(21) Appl. No.: 18/956,910

(22) Filed: Nov. 22, 2024

Related U.S. Application Data
(63) Continuation of application No. PCT/EP2022/064085, filed on May 24, 2022.

(51) Int. Cl. H02M 7/23; H02M 1/00; H02M 1/12; H02M 1/14

(52) U.S. Cl. CPC H02M 7/23; H02M 1/0058; H02M 1/12; H02M 1/14

(57) ABSTRACT

A power converter arrangement for power conversion in a single-phase power network, where the power converter arrangement comprises an input filter coupled to a first phase terminal to receive a first AC voltage, the input filter being configured to filter the first AC voltage to provide an input voltage; an electrical switching network comprising an array of bidirectional switches and an output terminal, the array of bidirectional switches being configured to generate a switched voltage from the input voltage at the output terminal. The electrical switching network comprises a decoupling capacitor to reduce undesirable oscillations at the output terminal; and a resonant circuit configured to convert the switched voltage into a supply voltage for supplying a load.

### CROSS-REFERENCE TO RELATED APPLICATIONS

This is a continuation of International Patent Application No. PCT/EP2022/064085 filed on May 24, 2022, the disclosure of which is hereby incorporated by reference in its entirety.

### TECHNICAL FIELD

The present disclosure relates to the field of power conversion in single-phase and multi-phase power networks. In particular, the disclosure relates to a power conversion arrangement and corresponding method for power conversion in a single-phase power network and to a power conversion arrangement and corresponding method for power conversion in a multi-phase power network in which at least one phase terminal is non-operational. More specifically, the disclosure relates to an apparatus and operation method of a one-phase direct resonant converter.

### BACKGROUND

Direct resonant converters which are based on a matrix-converter followed by a resonant tank are becoming increasingly popular as they offer a single alternating current/direct current (AC/DC) conversion with reduced switching losses when operating with Model Predictive Control. In some applications, e.g., on-board chargers, for instance, the input can be either three-phase or single-phase. When the input is single-phase, a double-line frequency ripple (typically 100 hertz (Hz) in a 50 Hz system) from the grid is transferred to the load. In the case of electric vehicles (EVs), this is not acceptable as it is detrimental to the battery's health. Additional strategies are required to prevent the appearance of this double-line frequency ripple in the power delivered to the load.

### SUMMARY

This disclosure provides a solution for power conversion in the above-described applications without the above-described disadvantages.

In particular, the disclosure provides a power conversion arrangement in which no detrimental double-line frequency ripple is transferred to the load or is at least strongly attenuated.

The foregoing and other objects are achieved by the features of the independent claims. Further implementation forms are apparent from the dependent claims, the description, and the figures.

The disclosure presents a novel apparatus and control method for direct AC/DC conversion compatible with both three-phase and single-phase grid input. The topology is a single-phase to single-phase Direct Matrix Resonant Converter operated with Model Predictive Control. By adding a leg of switches, the voltage across a decoupling capacitor can be controlled to absorb the double-line frequency ripple on the DC side. The extra switches can be operated with soft switching conditions, increasing the performance. Additionally, the converter can be connected to a three-phase grid. In this case, the input filter capacitor can play the role of the decoupling capacitor. The control strategy results in sinusoidal input currents and constant output power at all times.

The disclosure presents an apparatus and control method for direct AC/DC conversion by using a single-phase Direct Resonant Converter operated with a novel control algorithm. The key features are the following: 1) The addition of a power decoupling circuit with two bidirectional switches and a capacitor to store the double-line-frequency power ripple at the output caused by single-phase operation. 2) The control strategy which calculates the voltage needed at the capacitor to store the power ripple and forces the capacitor to follow that reference. 3) The control strategy which enables soft-switching operation in all the matrix switches and the additional power decoupling switches. 4) The additional branch together with the capacitor can be used to operate the converter with three-phase grid input. In this case, the input filter capacitor can be used as a decoupling element.

In order to describe the disclosure in detail, the following terms, abbreviations, and notations will be used:
EV electric vehicle
DC direct current
AC alternating current
DRC direct matrix resonant converter
MPC model predictive control
ZCS zero current switching
PWM pulse width modulation

In this disclosure, power networks or power grids are described. Such a power network or grid is an interconnected network for delivering or distributing electricity from producers to consumers. It may comprise generating stations that produce electric power, electrical substations for stepping electrical voltage up for transmission or down for distribution, high voltage transmission lines that carry power from distant sources to demand centers, and distribution lines that connect individual customers.

Power converters and power converter arrangements as described in this disclosure are applied for converting electric energy from one form to another, e.g., for converting between AC and DC. The Power converter arrangements can also change the voltage or frequency or some combination of these. Power converter arrangements are based on power electronics switches that can be actively controlled by applying ON/OFF logic (i.e., PWM operation, usually commanded by a closed-loop control algorithm).

A controller or controlling device as described in this disclosure is any device that can be utilized for the regulation of voltage, currents, or powers of a power converter arrangement. A controller or controlling device can be a single micro-controller or processor or a multi-core processor or can include a set of micro-controllers or processors or can include means for controlling and/or processing. The controller can perform specific control tasks, for example controlling a converter, according to a software, hardware, or firmware application.

In this disclosure, direct matrix resonant converters (DRCs) with MPC are described.

Direct resonant converters which are based on a matrix-converter followed by a resonant tank offer a single AC/DC conversion with reduced switching losses when operating with Model Predictive Control. In some applications, (e.g., on-board chargers), for instance, the input can be either 3-phase or 1-phase. When the input is 1-phase, a double line frequency ripple from the grid is transferred to the load.

In the operation of the MPC, the control evaluates all the possible switching states, e.g., as shown in FIG. 6, and chooses the one that minimizes a predetermined cost function, e.g. as described below with respect to FIG. 2. Different cost functions can be applied for this MPC strategy by considering the error between a reference and measured value for the: input currents, output current, or both, for example.

For the 3-phase MPC as one example, there can be six possible active states and three zero states. The current circulating through the switches is the current through the resonant tank. By performing the switching events at every zero-crossing of the tank current, zero-current switching is achieved, reducing switching losses. Each selected state is held during half of the period of resonance of the tank. This way, the tank operates at its resonant frequency, and the current through it can be assumed sinusoidal.

The discretized forms of the state space equations of the input filter and the resonant circuit are used to estimate the variations in the input and output current when a selected state is applied. The optimal state at each sampling time is selected based on a cost function, which evaluates the deviation of the predicted currents from the reference values (obtained from the power balance). The cost function can consider only the input currents, only the output currents, or both. When both references are considered, weighting factors are applied to adjust the relevance of each reference parameter. The control strategy and architecture result in sinusoidal input currents and constant power transfer. The “Input+Output” control results in superior performance: lower input and output ripples.

During the operation of a single-phase DRC, regardless of the control method, a double-line frequency ripple will appear at the output as shown in FIG. 7A. Additionally, the input currents are also susceptible to distortions as can be seen in FIG. 7B.

In this disclosure, a single-phase converter is presented together with a control method that allows achieving soft switching in all the devices while avoiding the double line-frequency ripple in the output. More details are presented in the following embodiments.

According to a first aspect, the disclosure relates to a power converter arrangement for power conversion in a single-phase power network, the single-phase power network comprising a first phase terminal configured to provide a first AC voltage, the power converter arrangement comprising: an input filter coupled to the first phase terminal of the single-phase power network to receive the first AC voltage, the input filter being configured to filter the first AC voltage to provide an input voltage; an electrical switching network comprising an array of bidirectional switches and an output terminal, the array of bidirectional switches being configured to generate a switched voltage from the input voltage at the output terminal, wherein the electrical switching network comprises a decoupling capacitor to reduce undesirable oscillations at the output terminal; and a resonant circuit configured to convert the switched voltage into a supply voltage for supplying a load.

Such a power converter arrangement advantageously inhibits the transfer of double-line frequency ripple to the load, since this distortion is damped or mitigated by the decoupling capacitor.

By adding a leg of switches, the voltage across a decoupling capacitor can be controlled to absorb the double-line frequency ripple on the DC side. The extra switches can be operated with soft switching conditions, for example, increasing the performance. The converter is flexible and can also be connected to a three-phase grid as described below as the second aspect. In this case, the input filter capacitor can play the role of the decoupling capacitor. The control strategy results in sinusoidal input currents and constant output power at all times.

In an exemplary implementation of the power converter arrangement, the power converter arrangement comprises: a controller configured to provide a switching signal to the array of bidirectional switches of the electrical switching network based on electric measurements at the first phase terminal of the single-phase power network, electric measurements of components of the input filter, electric measurements across the resonant circuit, electric measurements at an input of the switching network, and a voltage measurement across the decoupling capacitor, in which the controller ensuring that voltages and currents of the power converter arrangement, which are associated with the measurements, follow predefined reference values.

This provides the advantage that the controller can ensure that the state variables of the system (voltages and/or currents) follow their predefined reference values, improving the efficiency of power conversion. Electric measurements as described above include voltage and/or current measurements.

In an exemplary implementation of the power converter arrangement, the decoupling capacitor and the switches of the switching network are configured to reduce double line frequency harmonics from the single-phase power network, the single-phase power network operating at the line frequency. The line frequency means here the frequency of the grid, i.e., the power network.

This provides the advantage that undesirable oscillations at the output terminal can be efficiently and reliably reduced.

In an exemplary implementation of the power converter arrangement, the controller is configured to provide the switching signal to turn-on/off the array of bidirectional switches during a zero crossing of the switched voltage or a zero-crossing of a corresponding current of the resonant circuit to reduce or eliminate switching losses of the array of switches.

This provides the advantage that soft-switching can be enabled which reduces switching losses and results in higher efficiency and lower thermal stress of the devices.

In an exemplary implementation of the power converter arrangement, the switching network comprises a plurality of branches of bidirectional switches, wherein the branches are connected in parallel to form legs of the switching network, wherein the decoupling capacitor is connected to a midpoint of one of the legs of the switching network.

This provides the advantage that the decoupling capacitor can efficiently balance between the two terminals of the switching network in order to improve the mitigation of undesired oscillations.

In an exemplary implementation of the power converter arrangement, the branch of the plurality of branches, to which the decoupling capacitor is connected, forms a decoupling branch for decoupling undesirable oscillations at the output terminal.

This provides the advantage that the undesired oscillation can be decoupled by the decoupling branch without influencing the switching behavior of the other branches.

In an exemplary implementation of the power converter arrangement, the switching network comprises: a first input node and a second input node for receiving the input voltage; a first output node and a second output node for providing the switched voltage; a first branch and a second branch of bidirectional switches connected in parallel between the first output node and the second output node; and a decoupling branch of bidirectional switches connected in parallel to the first branch and the second branch of bidirectional switches between the first output node and the second output node, wherein the decoupling capacitor is connected to the decoupling branch.

This provides the advantage of a symmetric structure which facilitates the decoupling of undesired oscillations.

In an exemplary implementation of the power converter arrangement, each branch of bidirectional switches comprises two bidirectional switches which are connected to an intermediate node of the respective branch, wherein the intermediate node of the first branch is connected to the first input node of the switching network; wherein the intermediate node of the second branch is connected to the second input node of the switching network; and wherein the decoupling capacitor is connected between the intermediate node of the decoupling branch and a ground terminal.

According to a second aspect, the disclosure relates to a power converter arrangement for power conversion in a multi-phase power network, the multi-phase power network comprising a plurality of phase terminals, each phase terminal being configured to provide an AC voltage with a different voltage phase, wherein at least one phase terminal of the multi-phase power network is not operational, the power converter arrangement comprising: an input filter coupled to the plurality of phase terminals of the multi-phase power network to receive a respective AC voltage, the input filter being configured to filter the respective AC voltage to provide a respective input voltage; an electrical switching network comprising an array of bidirectional switches and an output terminal, the array of bidirectional switches being configured to generate a switched voltage from the respective input voltages at the output terminal, wherein the input filter comprises an input filter capacitor which has an additional function of reducing undesirable oscillations at the output terminal of the electrical switching network; and a resonant circuit configured to convert the switched voltage into a supply voltage for supplying a load.

Such a power converter arrangement advantageously inhibits the transfer of double-line frequency ripple to the load, since this distortion is damped or mitigated by the input filter capacitor. This converter is compatible with both single and three-phase connections to the grid. This results in high flexibility of operation which makes it suitable for applications as on-board chargers.

In contrast to the single-phase power network defined in the first aspect above, in this multi-phase power network, the switching network has no decoupling branch. The switches that were used in the decoupling branch of the single-phase power network no longer work as decoupling circuit, but they can be used as the third leg of switches which is necessary for a three-phase input system.

The controller can remain the same as for the first aspect described above.

Extra components may be needed to be added to the input filter to cover all input phases.

When operating with three-phase input, the capacitor no longer works as a decoupling capacitor but as the input filter capacitor. When one or more phases are not operational, the capacitor plays the role of a decoupling capacitor similar to the one of the first aspect above.

In an exemplary implementation of the power converter arrangement, the power converter arrangement comprises: a controller configured to provide a switching signal to the array of bidirectional switches of the electrical switching network based on electric measurements at at least one of the phase terminals of the multi-phase power network, electric measurements of components of the input filter, electric measurements across the resonant circuit, a measurement of the input voltages at an input of the switching network, and a voltage measurement across the input filter capacitor, the controller ensuring that voltages and currents of the power converter arrangement, which are associated with the measurements, follow predefined reference values.

This provides the advantage that the controller can ensure that the state variables of the system (voltages and/or currents) follow their predefined reference values, improving the efficiency of power conversion. Electric measurements as described above include voltage and/or current measurements.

In an exemplary implementation of the power converter arrangement, the input filter capacitor of the disconnected phase is configured to reduce double line frequency harmonics from the at least one non-operational phase terminal of the multi-phase power network, wherein the multi-phase power network operates at the line frequency.

This provides the advantage that undesirable oscillations at the output terminal can be efficiently and reliably reduced.

For example, phase A is working and C is disconnected, therefore, the capacitor at phase C can be the decoupling capacitor. It understands that other implementations can be used as well, for instance, if phase A not working, then its capacitor will be the decoupling one.

In an exemplary implementation of the power converter arrangement, the input filter for each phase terminal comprises a respective input filter capacitor.

This power converter arrangement provides the advantage of high flexibility against loss of operation in one or more phases.

In an exemplary implementation of the power converter arrangement, the input filter capacitors of each phase terminal are interconnected in a Y-configuration or in a Delta-configuration.

This means that the input filter capacitors may be connected differently.

In an exemplary implementation of the power converter arrangement, the controller is configured to determine deviations of the measurements from their reference values and to determine the switching signal based on a cost function of the deviations.

This provides the advantage that the states of this converter can be efficiently and reliably controlled.

In an exemplary implementation of the power converter arrangement, the controller is configured to determine a configuration of the array of bidirectional switches which configuration is associated with a minimum of the cost function and to provide the switching signals in accordance with the configuration associated with the minimum of the cost function.

This provides the advantage that the bidirectional switches can be controlled in order to achieve optimal performance of power conversion.

In an exemplary implementation of the power converter arrangement, the controller is configured to determine the reference values based upon a balance of a power of the single-phase or multi-phase power network with respect to a power at the load, a power across the decoupling capacitor, a power in the input filter and a loss power.

This provides the advantage that power equations can be derived for determining the power balance and by using these power equations, the power converter arrangement can be optimally controlled.

For the multi-phase power network, measurements must be taken at all three phases and reference values must be determined for all three phases.

In an exemplary implementation of the power converter arrangement, the controller is configured to determine the power, the voltage, and/or a current across the decoupling capacitor in order to ensure that the power at the load is constant.

This provides the advantage that all desired states of the system are known and the power converter can be optimally controlled.

The resonant circuit may comprise a transformer and a rectifier stage connecting the transformer to the load.

The input filter may comprise one of the following: a shunt R-C damping network, a series damping resistive element with parallel inductive element, a cascaded filter with parallel R-L damping in each section.

The resonant circuit can be of any kind such as: a series LC circuit, a series-parallel loaded LC circuit, a parallel LC circuit, an LCC circuit, etc.

The resonant circuit may comprise a transformer with an integrated resonant tank.

According to a third aspect, the disclosure relates to a method for power conversion in a single-phase power network, the single-phase power network comprising a first phase terminal configured to provide a first AC voltage, the method comprising: filtering the first AC voltage of the first phase terminal of the single-phase power network to provide an input voltage; generating a switched voltage from the input voltage by an array of bidirectional switches of an electrical switching network, wherein the switched voltage is generated at an output terminal of the switching network; reducing undesirable oscillations at the output terminal by a decoupling capacitor of the switching network; and converting, by a resonant circuit, the switched voltage into a supply voltage for supplying a load.

Such a method provides the same advantages as the power converter arrangement according to the first aspect. The method advantageously inhibits the transfer of double-line frequency ripple to the load, since this distortion is damped or mitigated by the decoupling capacitor.

According to a fourth aspect, the disclosure relates to a method for power conversion in a multi-phase power network, the multi-phase power network comprising a plurality of phase terminals, each phase terminal being configured to provide an AC voltage with a different voltage phase, wherein at least one phase terminal of the multi-phase power network is not operational, the method comprising: filtering, by an input filter, an AC voltage received from a respective phase terminal of the multi-phase power network to provide a respective input voltage; generating a switched voltage from the respective input voltages by an array of bidirectional switches of an electrical switching network, wherein the switched voltage is generated at an output terminal of the switching network; reducing undesirable oscillations at the output terminal by an input filter capacitor of the input filter; and converting, by a resonant circuit, the switched voltage into a supply voltage for supplying a load.

Such a method provides the same advantages as the power converter arrangement according to the second aspect. The method advantageously inhibits the transfer of double-line frequency ripple to the load, since this distortion is damped or mitigated by the input filter capacitor.

According to a fifth aspect, the disclosure relates to a computer program product including computer executable code or computer executable instructions that, when executed, causes at least one computer to execute the method according to the third or fourth aspect described above.

The computer program product may run on a controller for controlling the above-described power converter arrangement, e.g., a controller 170 as shown in FIGS. 1A-1B.

According to a sixth aspect, the disclosure relates to a computer-readable medium, storing instructions that, when executed by a computer, cause the computer to execute the method according to the third or fourth aspect described above. Such a computer readable medium may be a non-transient readable storage medium. The instructions stored on the computer-readable medium may be executed by the controller as described in FIGS. 1A-1B.

### BRIEF DESCRIPTION OF THE DRAWINGS

Further embodiments of the disclosure will be described with respect to the following figures, in which:

FIG. 1A shows a block diagram illustrating a power converter arrangement 100 for power conversion in a single-phase power network according to a first embodiment;

FIG. 1B shows a block diagram illustrating a power converter arrangement 200 for power conversion in a multi-phase network in which at least one phase terminal is not operational according to a second embodiment;

FIG. 2 shows a block diagram illustrating an exemplary control strategy for the power converter arrangements 100, 200 shown in FIGS. 1A-1B;

FIG. 3 shows a block diagram illustrating a power converter arrangement 300 for power conversion in a single-phase power network according to a third embodiment;

FIG. 4A shows an equivalent circuit of the single-phase Direct Resonant Converter shown in FIG. 3 illustrating the input and output of the matrix converter;

FIG. 4B shows an equivalent circuit of the single-phase Direct Resonant Converter shown in FIG. 3 illustrating an equivalent input filter circuit in the phase connected to the grid;

FIG. 4C shows an equivalent circuit of the single-phase Direct Resonant Converter shown in FIG. 3 illustrating an equivalent input filter circuit in the phase disconnected from the grid;

FIG. 4D shows an equivalent circuit of the single-phase Direct Resonant Converter shown in FIG. 3 illustrating the equivalent resonant circuit;

FIG. 5 shows a block diagram illustrating a schematic of the bridge and resonant circuit 500 of the power converter arrangement 300 shown in FIG. 3;

FIG. 6 shows a switching diagram 600 illustrating possible switching states for a power converter arrangement shown in FIG. 3 in single-phase operation;

FIG. 7A shows a performance diagram illustrating power delivered to the load for the disclosed power converter arrangement in comparison to another power converter;

FIG. 7B shows a performance diagram illustrating grid current in the connected phase for the disclosed power converter arrangement in comparison to another power converter;

FIG. 7C shows a performance diagram illustrating voltage across the input filter capacitor of the disconnected leg for the disclosed power converter arrangement in comparison to another power converter;

FIG. 8 shows a block diagram illustrating a power converter arrangement 800 for power conversion in a multi-phase power network in which at least one phase terminal is not operational according to a fourth embodiment;

FIG. 9 shows a block diagram illustrating different output configurations of an output voltage-doubler;

FIG. 10A shows a block diagram illustrating a shunt R-C damping network as an exemplary input filter topology for the disclosed power converter arrangements;

FIG. 10B shows a block diagram illustrating a damping network comprising series damping R with parallel L as an exemplary input filter topology for the disclosed power converter arrangements;

FIG. 10C shows a block diagram illustrating a damping network comprising a cascaded filter with parallel R-L damping in each section as an exemplary input filter topology for the disclosed power converter arrangements;

FIGS. 11A-11D show examples of possible resonant tank configurations with a) series, b) series-parallel loaded, c) parallel, and d) LCC for the disclosed power converter arrangements;

FIG. 12 shows a circuit diagram of a transformer with an integrated resonant tank for the disclosed power converter arrangements; and

FIG. 13 shows a schematic diagram illustrating methods 1300a and 1300b for power conversion in a single-phase power network or in a multi-phase power network in which at least one phase terminal is not operational.

### DETAILED DESCRIPTION OF EMBODIMENTS

In the following detailed description, reference is made to the accompanying drawings, which form a part thereof, and in which are shown by way of illustration, specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined, unless specifically noted otherwise.

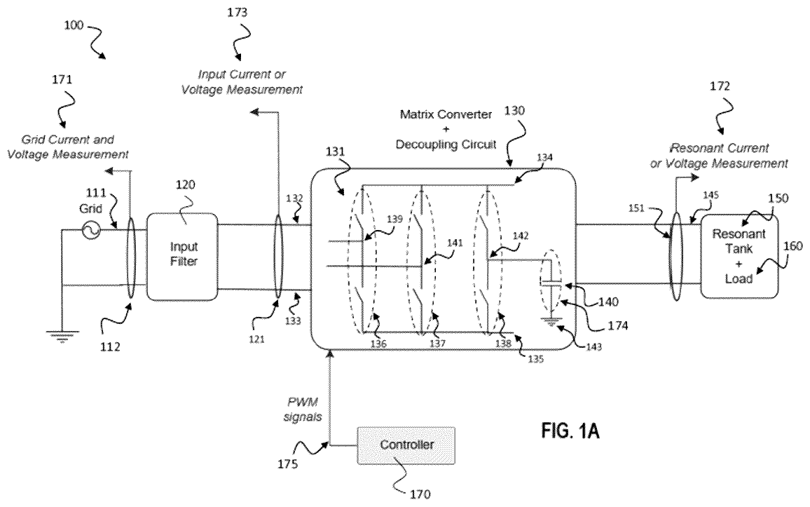

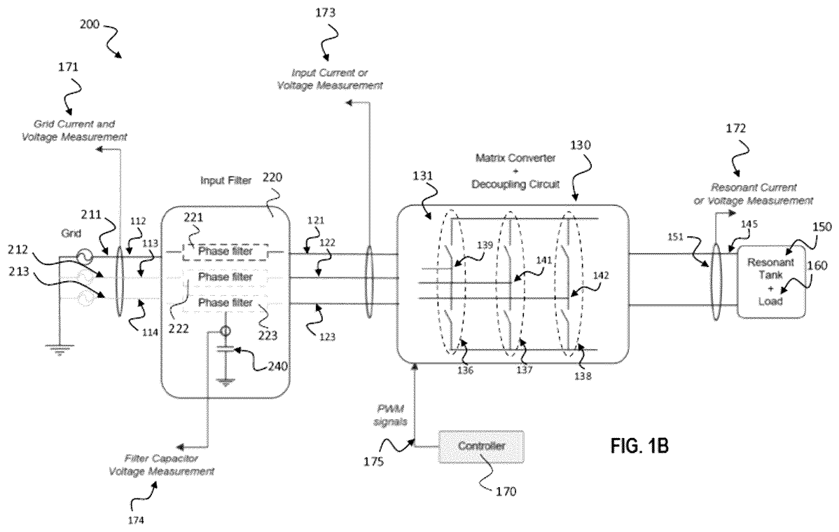

FIG. 1A shows a block diagram illustrating a power converter arrangement 100 for power conversion in a single-phase power network according to a first embodiment.

The first embodiment of the power converter arrangement 100 corresponds to a single-phase Direct Resonant Converter with an added decoupling circuit 138, formed by two additional bidirectional switches and a capacitor 140. Here, the grid is connected to a single-phase input filter 120, followed by a switching matrix. The power decoupling circuit 138 is connected to the output of the single-phase matrix converter. This circuit comprises an additional switching leg 138 with a capacitor 140 interconnected between its mid-point 142 and ground 143. The structure also includes a control block 170 which is in charge of the power factor correction, voltage and power regulation, and power decoupling.

All the individual switches depicted in FIG. 1A must enable the flow of current and voltage in both directions, e.g., bidirectional switches. The output of the single-phase matrix converter 130 is connected to a resonant tank 150 of any kind followed by the load 160. Depending on the requirements of the application, the load 160 can be either AC or DC, isolated or non-isolated. In the case of a DC-load, a rectification stage of any kind can be used.

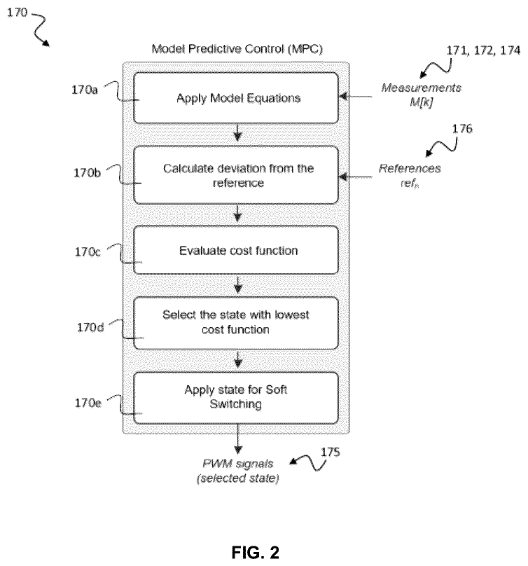

The controller 170 receives the measurements 171, 172, 173, 174 of currents and voltages from the grid side, at the input of the matrix converter 130, and in the resonant tank 150, and across the decoupling capacitor 140, as shown in FIG. 1A. The operation of the control method is described in the block diagram of FIG. 2. The controlled variables in the DRC operation with MPC are not only the grid current and the current through or voltage across the resonant tank (depending on the resonant circuit topology), but additionally the voltage across the additional capacitor for power decoupling. During operation, the decoupling capacitor 140 is controlled to absorb the double-line frequency ripple. The reference for the voltage across the capacitor is calculated by applying the power balance and the condition of constant output power.

In the following, a detailed description of the power converter arrangement 100 according to the first embodiment is presented.

The power converter arrangement 100 according to the first embodiment can be used for power conversion in a single-phase power network. This single-phase power network comprises a first phase terminal 111 configured to provide a first AC voltage 112 as shown in FIG. 1A.

The power converter arrangement 100 comprises an input filter 120 coupled to the first phase terminal 111 of the single-phase power network to receive the first AC voltage 112. The input filter 120 is configured to filter the first AC voltage 112 to provide an input voltage 121.

The power converter arrangement 100 comprises an electrical switching network 130 comprising an array of bidirectional switches 131 and an output terminal 145. The array of bidirectional switches 131 is configured to generate a switched voltage 151 from the input voltage 121 at the output terminal 145. The electrical switching network 130 comprises a decoupling capacitor 140 to reduce undesirable oscillations at the output terminal 145.

The power converter arrangement 100 comprises a resonant circuit 150 configured to convert the switched voltage 151 into a supply voltage for supplying a load 160.

The power converter arrangement 100 may further comprise a controller 170 configured to provide a switching signal 175 to the array of bidirectional switches 131 of the electrical switching network 130 based on electric measurements 171 at the first phase terminal 111 of the single-phase power network, electric measurements of components of the input filter 120, electric measurements 172 across the resonant circuit 150, electric measurements 173 at an input of the switching network 130, and a voltage measurement 174 across the decoupling capacitor 140. The controller 170 is ensuring that voltages and currents of the power converter arrangement 100, which are associated with the measurements 171, 172, 173, 174, follow predefined reference values.

In particular, the controller 170 makes sure that the state variables of the system (voltages and/or currents) follow their predefined reference values.

Electric measurements as described above include voltage and/or current measurements.

The decoupling capacitor 140 and the switches of the switching network 130 may be configured to reduce double line frequency harmonics from the single-phase power network which operates at the line frequency.

The line frequency means here the frequency of the grid, i.e. the power network.

The controller 170 may be configured to provide the switching signal 175 to switch the array of bidirectional switches 131 during a zero crossing of the switched voltage 151 or a zero-crossing of a corresponding current of the resonant circuit 150 to reduce or eliminate switching losses of the array of switches 131.

The switching network 130 may comprise a plurality of branches 136, 137, and 138 of bidirectional switches. These branches 136, 137, 138 may be connected in parallel to form legs of the switching network 130. The decoupling capacitor 140 may be connected to a midpoint 142 of one of the legs (here leg 138) of the switching network 130.

The branch 138 of the plurality of branches 136, 137, and 138 to which the decoupling capacitor 140 is connected, forms a decoupling branch for decoupling undesirable oscillations at the output terminal 145.

The switching network 130 may comprise a first input node 132 and a second input node 133 for receiving the input voltage 121. The switching network 130 may comprise a first output node 134 and a second output node 135 for providing the switched voltage 151. The switching network 130 may comprise a first branch 136 and a second branch 137 of bidirectional switches connected in parallel between the first output node 134 and the second output node 135. The switching network 130 may comprise a decoupling branch 138 of bidirectional switches connected in parallel to the first branch 136 and the second branch 137 of bidirectional switches between the first output node 134 and the second output node 135, wherein the decoupling capacitor 140 is connected to the decoupling branch 138.

Each branch 136, 137, 138 of bidirectional switches comprises two bidirectional switches which are connected to an intermediate node 139, 141, 142 of the respective branch 136, 137, 138. The intermediate node 139 of the first branch 136 can be connected to the first input node 132 of the switching network 130. The intermediate node 141 of the second branch 137 can be connected to the second input node 133 of the switching network 130. The decoupling capacitor 140 can be connected between the intermediate node 142 of the decoupling branch 138 and a ground terminal 143.

The controller 170 may be configured to determine deviations of the measurements 171, 172, 173 174 from their reference values and to determine the switching signal 175 based on a cost function of the deviations, e.g., as described below concerning FIG. 2.

The controller 170 may be configured to determine a configuration of the array of bidirectional switches 131 which is associated with a minimum of the cost function and to provide the switching signal 175 in accordance with the configuration associated with the minimum of the cost function.

The controller 170 may be configured to determine the reference values based upon a balance of a power of the single-phase or multi-phase power network with respect to a power at the load 160, a power across the decoupling capacitor 140, a power in the input filter 120 and a loss power.

The controller 170 may be configured to determine the power, the voltage and/or a current across the decoupling capacitor 140 in order to force the power at the load 160 to be constant.

The resonant circuit 150 may comprise a transformer and a rectifier stage connecting the transformer to the load 160.

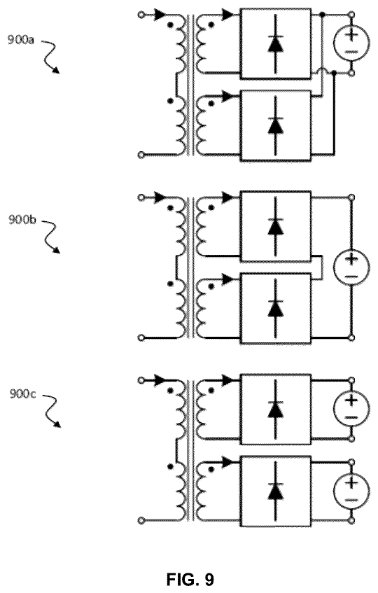

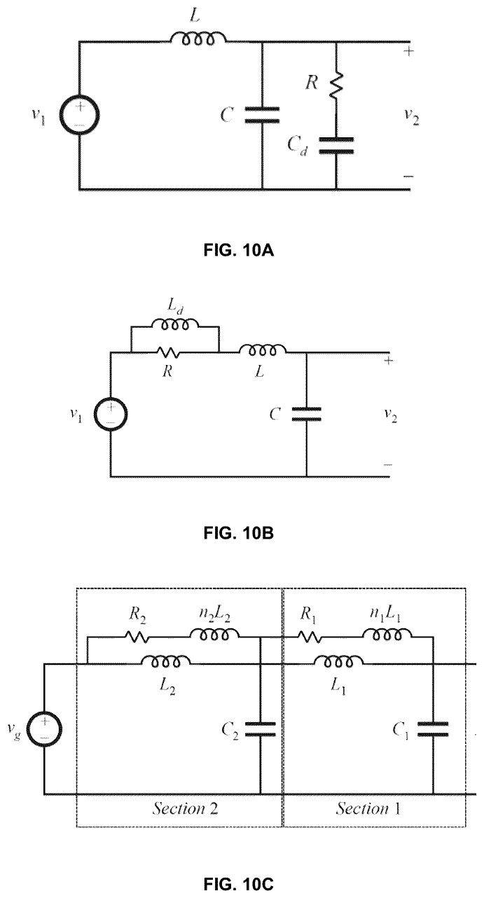

The input filter 120 may comprise one of the following: a shunt R-C damping network, e.g., as shown in FIG. 10A, a series damping resistive element with parallel inductive element, e.g., as shown in FIG. 10B, a cascaded filter with parallel R-L damping in each section, e.g., as shown in FIG. 10C.

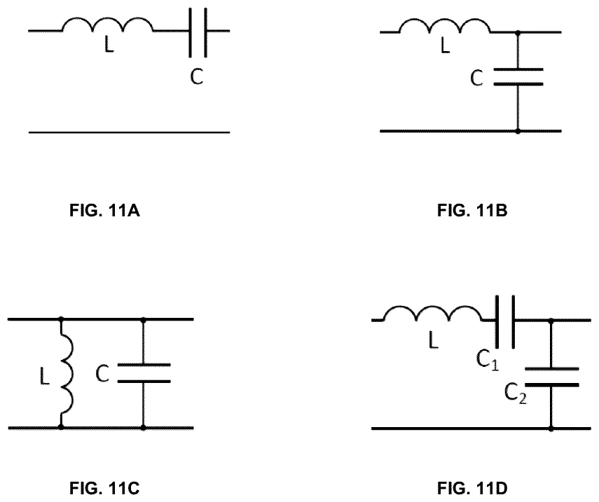

The resonant circuit (150) can be of any kind such as: a series LC circuit, e.g., as shown in FIG. 11A, a series-parallel loaded LC circuit, e.g., as shown in FIG. 11B, a parallel LC circuit, e.g., as shown in FIG. 11C, an LCC circuit, e.g., as shown in FIG. 11D.

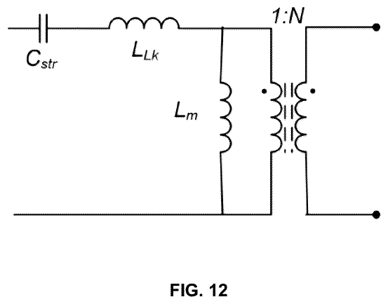

The resonant circuit (150) may comprise a transformer with an integrated resonant tank, e.g., as shown in FIG. 12.

FIG. 1B shows a block diagram illustrating a power converter arrangement 200 for power conversion in a multi-phase network in which at least one phase terminal is not operational according to a second embodiment.

The power converter arrangement 200 according to the second embodiment can be used for power conversion in a multi-phase power network. This multi-phase power network comprises a plurality of phase terminals 211, 212, and 213, each phase terminal being configured to provide an AC voltage with a different voltage phase. At least one phase terminal 212, 213 of the multi-phase power network is not operational, as illustrated by the light grey lines in FIG. 1B. While FIG. 1B shows the phase terminals 212, and 213 as not operational, it understands that any one or two other of the phase terminals 211, 212, or 213 can be non-operational.

The power converter arrangement 200 comprises an input filter 220 coupled to the plurality of phase terminals 211, 212, and 213 of the multi-phase power network to receive a respective AC voltage 112, 113, 114. The input filter 220 is configured to filter the respective AC voltage 112, 113, and 114 to provide a respective input voltage 121, 122, and 123.

The power converter arrangement 200 comprises an electrical switching network 130 comprising an array of bidirectional switches 131 and an output terminal 145. The array of bidirectional switches 131 is configured to generate a switched voltage 151 from the respective input voltages 121, 122, and 123 at the output terminal 145. The input filter 220 comprises an input filter capacitor 240 which has an additional function of reducing undesirable oscillations at the output terminal 145 of the electrical switching network 130.

The power converter arrangement 200 comprises a resonant circuit 150 configured to convert the switched voltage 151 into a supply voltage for supplying a load 160.

The power converter arrangement 200 may further comprise a controller 170 configured to provide a switching signal 175 to the array of bidirectional switches 131 of the electrical switching network 130 based on electric measurements 171 at at least one of the phase terminals 211, 212, 213 of the multi-phase power network, electric measurements of components 221, 222, 223 of the input filter 220, electric measurements 172 across the resonant circuit 150, a measurement 173 of the input voltages 121, 122, 123 at an input of the switching network 130, and a voltage measurement 174 across the input filter capacitor 240. The controller 170 ensures that voltages and currents of the power converter arrangement 200, which are associated with the measurements 171, 172, 173, and 174, follow predefined reference values.

Electric measurements as described above include voltage and/or current measurements.

In contrast to the single-phase power network described above concerning FIG. 1A, in this multi-phase power network, the switching network has no decoupling branch. The switches that were used in the decoupling branch of the single-phase power network no longer work as part of the decoupling circuit, but they can be used as the third leg of switches which is necessary for a three-phase input system. The controller 170 can remain the same.

Extra components may be needed to be added to the input filter to cover all input phases.

When operating with three-phase input, the capacitor 240 no longer works as a decoupling capacitor but as the input filter capacitor. When one or more phases are not operational, the capacitor 240 plays the role of a decoupling capacitor similar to the one described above with respect to FIG. 1A for the single-phase power network.

The input filter capacitor 240 of the disconnected phase may be configured to reduce double line frequency harmonics from the at least one non-operational phase terminal 212, 213 of the multi-phase power network which operates at the line frequency.

In FIG. 1B, phase A is working and C is disconnected; Therefore, the capacitor 240 is the decoupling capacitor. It understands that other implementations can be used as well, for instance, if phase A is not working and then its capacitor will be the decoupling one.

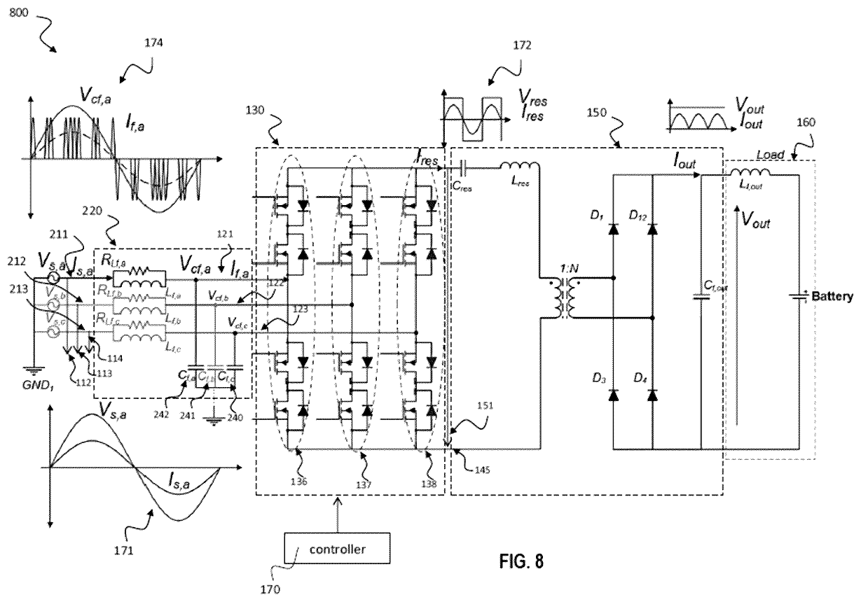

The input filter 220 may comprise for each phase terminal 211, 212, 213 a respective input filter capacitor 240. In FIG. 1B, only the input filter capacitor 240 for the phase terminal 213 is shown. It understands that the phase terminals 211 and 212 may also comprise respective input filter capacitors 242, 241, e.g., according to the representation shown in FIG. 8.

The input filter capacitors 242, 241, and 240 (e.g., as shown in FIG. 8) of each phase terminal 211, 212, and 213 can be interconnected in a Y-configuration or a Delta-configuration.

The controller 170 may be implemented corresponding to the controller 170 described above with respect to FIG. 1A.

I.e., the controller 170 may be configured to determine the reference values based upon a balance of a power of the single-phase or multi-phase power network with respect to a power at the load 160, a power across the decoupling capacitor 240, a power in the input filter 220 and a loss power.

For the multi-phase power network, measurements must be taken at all three phases and reference values must be determined for all three phases.

FIG. 2 shows a block diagram illustrating an exemplary control strategy for the power converter arrangements 100, and 200 shown in FIGS. 1A-1B.

The control strategy performed by the controller 170 as shown in FIGS. 1A-1B uses MPC based on the measurements 171, 172, 173, 174 and the references 176 shown in FIGS. 1A-1B and FIG. 2 to determine the PWM signals 175 as control signals. The control strategy includes the following: Apply Model Equations 170a based on the measurements 171, 172, 173, 174; Calculate deviation 170b from the reference based on the references 176; Evaluate 170c cost function; Select 170d the state with the lowest cost function; and Apply 170e state for Soft Switching to determine the output PWM signals 175 corresponding to the selected state.

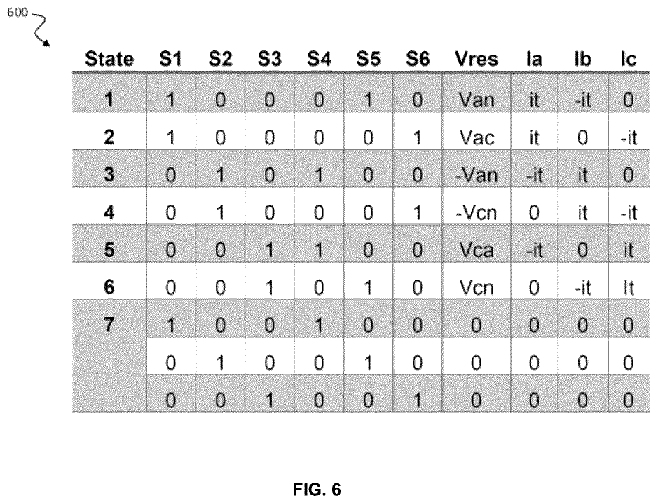

In the operation of the MPC, the control strategy evaluates all the switching states, e.g., as shown in FIG. 6, and chooses the one that minimizes a predetermined cost function, e.g. as described below with respect to FIG. 2. Different cost functions can be applied for this MPC strategy by considering the error between a reference and measured value for the: input currents, output current, or both, for example.

Depending on the selected filter and resonant circuit topologies, the mathematical models used by the controller 170 will change. However, the procedure to derive these expressions is always the same. First, the equivalent circuit of an input filter, resonant tank, and decoupling capacitor are obtained. The state-space equations are derived and their discretized form is used to predict the controlled variables value in every switching instant k for each of the possible switching states j.

$${Var}^{j} [ k + 1 ] = g ( measurements [ k ] , system parameters ) \qquad ( 1 )$$

Apart from the filter and resonant tank states, another required state is the voltage across the decoupling capacitor. Next, the reference values for all the states are obtained from the power balance equations. For the capacitor voltage, the power delivered to the load is forced to be constant; i.e.:

$${P}_{grid} = {P}_{load} + {P}_{capacitor} + {P}_{loss} \qquad ( 2 )$$

$${P}_{load} ( {θ}_{s} ) = P ; for all {θ}_{s} ∈ ( 0 , 2 π ) \qquad ( 3 )$$

The deviation of every controlled variable from the reference value is calculated at the sampling instant for each possible switching state.

$${error}_{var}^{j} = \frac{\vert {Var}^{j} [ k + 1 ] - {ref}_{var} \vert}{{ref}_{var}} \qquad ( 4 )$$

For the selection of the optimal switching state, these deviations are combined in a cost function. Weighting factors λᵢ are used to give different relevance to each controlled variable i. The selected state will be the one that achieves lowest value of the cost function. This sequence of steps is repeated at every switching instance.

$${cost}^{j} = {\sum }_{i} {λ}_{i} {error}_{i} \qquad ( 5 )$$

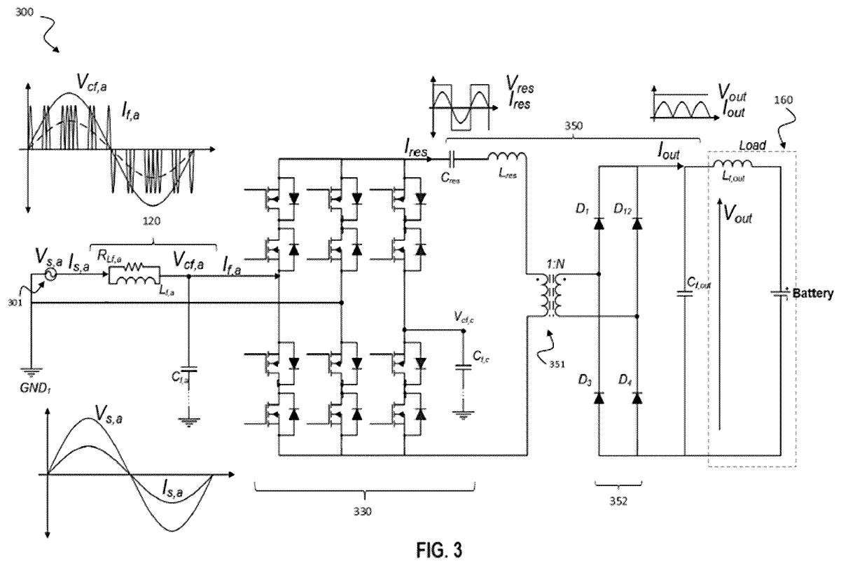

FIG. 3 shows a block diagram illustrating a power converter arrangement 300 for power conversion in a single-phase power network according to a third embodiment.

For this third embodiment of the power converter arrangement 300, a more detailed description is presented in the following and applied to an exemplary case of a DRC 330 followed by a series resonant tank 350. Here two switches are used per position. The bridge is connected to the grid 301 through an input filter 120 formed by an inductor L_{f,a}, a capacitor C_{f,a}, and a damping resistor R_{Lf,a}, as shown in FIG. 3. On the load side, a transformer 351 may be (although not necessarily) added to provide isolation. For this embodiment, the load 160 comprises a rectifier stage 352 which connects the transformer 351 to load 160, for instance, the battery of an EV.

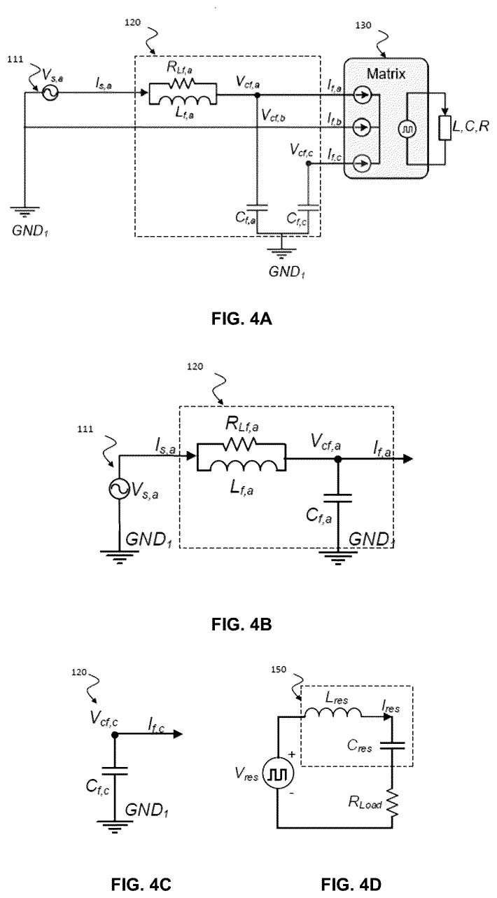

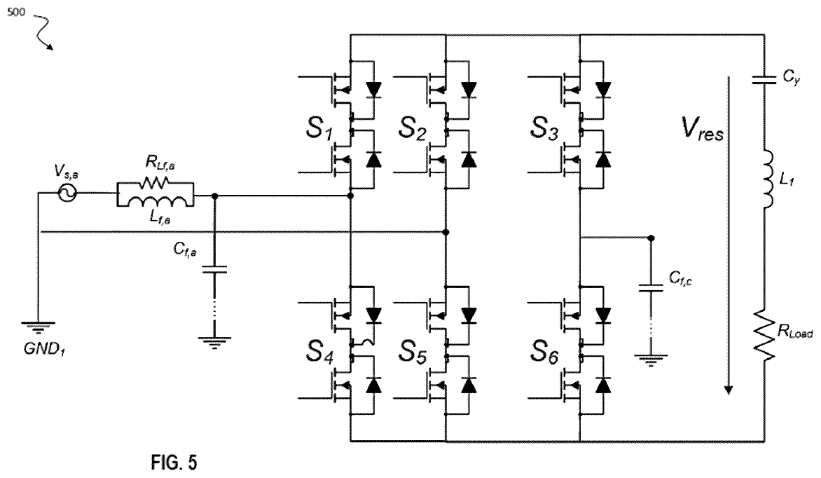

In the following, the equations used for the control algorithm and their derivation will be explained in detail for this embodiment without loss of generality. Similar derivations can be done for other input filters and resonant tanks. The equivalent circuits for this embodiment are represented in FIGS. 4A-4D. In FIG. 5 and FIG. 6 all the possible switching states are presented.

The input currents, tank current or both are controlled to follow a reference. The discretized equations of the input filter are used to predict the variation of the input current according to the selected switching state. The input current in the next sampling time [k+1] is evaluated based on measurements at time instant [k] and the known system parameters (Aₚ) as shown below:

$${I}_{s , a}^{j} [ k + 1 ] = f ( {i}_{s , a} [ k ] , {V}_{cf , a} [ k ] , {V}_{s , a} [ k ] , {V}_{s , a} [ k + 1 ] , {I}_{f , a}^{j} [ k ] , {A}_{p , a} ) \qquad ( 6 )$$

$${V}_{cf , a}^{j} [ k + 1 ] = g ( {i}_{s , a} [ k ] , {V}_{cf , a} [ k ] , {V}_{s , a} [ k ] , {I}_{f , a}^{j} [ k ] , {A}_{p , a} ) \qquad ( 7 )$$

Where j∈(0 . . . 7) refers to the states. The reference currents are obtained from the power balance equation:

$${I}_{s , a}^{*} = \frac{2 {P}_{o}}{3 η \vert {V}_{s , a} \vert} \times sin ( {ω}_{s} + {θ}_{s , a} ) ; {θ}_{s , a} ∈ ( 0 , \frac{2 π}{3} , \frac{4 π}{3} ) \qquad ( 8 )$$

In a similar manner, the discretized equations of the resonant circuit are used to predict the variation of the output current according to the selected switching state. The current circulating through the resonant tank in the next sampling time [k+1] is evaluated based on measurements at time instant [k] and the known system parameters (Bₚ):

$${I}_{res}^{j} [ k + 1 ] = h ( {I}_{res} [ k ] , {V}_{res}^{j} , {B}_{p , a} ) \qquad ( 9 )$$

The variation of the voltage across the decoupling capacitor according to the selected switching state can be predicted using the discretized equations. The voltage of the decoupling capacitor in the next sampling time [k+1] is also estimated based on measurements at time instant [k] and the known system parameters (Aₚ):

$${V}_{cfc}^{j} [ k + 1 ] = g ( {V}_{cfc} [ k ] , {I}_{f , a} [ k ] , {A}_{pc} ) \qquad ( 10 )$$

The reference voltage is obtained from the power balance and the condition of constant output power. The derivation of this reference voltage for the exemplary case of embodiment 1 is described as follows.

In the following, derivation of the reference magnitude and phase of the decoupling capacitor voltage is presented.

The instantaneous power provided by phase a of the grid can be expressed as:

$${P}_{s} ( t ) = {v}_{s , a} ( t ) {i}_{s , a} ( t ) = {V}_{s} sin ( {ω}_{s} t ) {I}_{s} sin ( {ω}_{s} t ) = \frac{{V}_{s} {I}_{s}}{2} ( 1 - cos ( 2 {ω}_{s} t ) ) \qquad ( 11 )$$

Where Vₛ, Iₛ, ωₛ are the peak voltage and current and the frequency of the grid. Neglecting the losses for simplicity, the power balance results in:

$${P}_{s} ( t ) = {P}_{load} ( t ) + {P}_{cf , a} ( t ) + {P}_{cf , c} \qquad ( 12 )$$

Since the required load power is constant, the double-line frequency power ripple must be stored by the capacitors:

$${P}_{load} ( t ) = \frac{{V}_{s} {I}_{s}}{2} = P ; \qquad ( 13 )$$

$${P}_{cf , a} ( t ) + {P}_{cf , c} = - \frac{{V}_{s} {I}_{s}}{2} cos ( 2 {ω}_{s} t )$$

The voltage and current through capacitor in a depend on the grid voltage and current waveforms, so it is not controllable. Hence, we define the converter input power Pin as the power entering directly the matrix converter from phase a, and the power balance results as:

$${P}_{in} ( t ) = {P}_{load} ( t ) + {P}_{cap , C} ( t ) = P + {P}_{cap , C} ( t ) \qquad ( 14 )$$

The voltage and current in this capacitor can be expressed as:

$${v}_{cap , C} ( t ) = {V}_{c} sin ( {ω}_{s} t + {θ}_{{v}_{{C}_{f}} , C} ) = \sqrt{\frac{2 {P}_{c}}{{ω}_{s} {C}_{f}}} sin ( {ω}_{s} t + {θ}_{{v}_{{C}_{f}} C} ) \qquad ( 15 )$$

$${i}_{cap , C} ( t ) = {I}_{c} sin ( {ω}_{s} t + \frac{π}{2} + {θ}_{{v}_{{C}_{f}} , C} ) = \sqrt{2 {P}_{c} {ω}_{s} {C}_{f}} sin ( {ω}_{s} t + \frac{π}{2} + {θ}_{{v}_{{C}_{f}} , C} ) \qquad ( 16 )$$

Where P_{c}=V_{c}I_{c}/2, C_{f} is the capacitance of the decoupling capacitor and

$${θ}_{{v}_{{C}_{f}} , C}$$

is the phase angle of the voltage across it. The instantaneous power in capacitor C is:

$${P}_{cap , C} ( t ) = {v}_{c} ( t ) {i}_{c} ( t ) = 2 {P}_{c} sin ( {ω}_{s} t + {θ}_{{v}_{{C}_{f}} , C} ) sin ( {ω}_{s} t + \frac{π}{2} + {θ}_{{v}_{{C}_{f}} , C} ) \qquad ( 17 )$$

Regarding the input power, the voltage drop across the filter inductor can be neglected, so the voltage across the filter capacitor in phase a can be considered approximately equal to the voltage in phase a of the grid, v_{s,A}. The grid current i_{s,A} is then divided between the current that charges and discharges the filter capacitor, i_{cap,a}, and the current that inputs the converter, i_{in,a}.

$${P}_{in} ( t ) = {v}_{cap , IB} ( t ) {i}_{in , a} ( t ) \approx {v}_{s , a} ( t ) ( {i}_{s , a} ( t ) - {i}_{cap , a} ( t ) ) \qquad ( 18 )$$

$${i}_{s , a} ( t ) = \frac{2 P}{{V}_{s}} sin ( {ω}_{s} t ) \qquad ( 19 )$$

$${i}_{cap , a} ( t ) = {ω}_{s} {C}_{f} {V}_{s} sin ( {ω}_{s} t + \frac{π}{2} ) \qquad ( 20 )$$

$${P}_{in} ( t ) \approx {V}_{s} sin ( {ω}_{s} t ) [ \frac{2 P}{{V}_{s}} sin ( {ω}_{s} t ) - {ω}_{s} {C}_{f} {V}_{s} sin ( {ω}_{s} t + \frac{π}{2} ) ] \qquad ( 21 )$$

Then, the instantaneous power in the load is:

$${P}_{load} ( t ) = {P}_{in} ( t ) - {P}_{cap , C} ( t ) \approx {V}_{s} sin ( {ω}_{s} t ) [ \frac{2 P}{{V}_{s}} sin ( {ω}_{s} t ) - {ω}_{s} {C}_{f} {V}_{s} sin ( {ω}_{s} t + \frac{π}{2} ) ] - 2 {P}_{c} sin ( {ω}_{s} t + {θ}_{{v}_{{C}_{f}} , C} ) sin ( {ω}_{s} t + \frac{π}{2} + {θ}_{{v}_{{C}_{f}} , C} ) \qquad ( 22 )$$

If the load power is a constant, the evaluation of equation (22) at every point of the period must be equal to the constant value P. As the ripple doubles the grid frequency, it is enough to evaluate the expression at 0° and 45° of the grid period:

$${ω}_{s} t = 0 \to - 2 {P}_{c} sin ( {θ}_{{v}_{{C}_{f}} , C} ) cos ( {θ}_{{v}_{{C}_{f}} , C} ) = P \qquad ( 23 )$$

$${ω}_{s} t = \frac{π}{4} \to P - \frac{{ω}_{s} {C}_{f} {V}_{s}^{2}}{2} + {P}_{c} ( {sin}^{2} ( {θ}_{{v}_{{C}_{f}} , C} ) - {cos}^{2} ( {θ}_{{v}_{{C}_{f}} , C} ) ) = P \qquad ( 24 )$$

Dividing (24)/(23), a second order equation for the tangent of the capacitor voltage phase angle can be found:

$${tan}^{2} ( {θ}_{{v}_{{C}_{f}} , C} ) + \frac{{ω}_{s} {C}_{f} {V}_{s}^{2}}{P} tan ( {θ}_{{v}_{{C}_{f}} , C} ) - 1 = 0 \to ( {θ}_{{v}_{{C}_{f}} , C} ) = \frac{- K \pm \sqrt{{K}^{2} + 4}}{2} \qquad ( 25 )$$

Where K is defined as

$$K = \frac{{ω}_{s} {C}_{f} {V}_{s}^{2}}{P} .$$

And from (23) P_{c} can be obtained:

$${P}_{c} = - \frac{P}{2 sin ( {θ}_{{v}_{{C}_{f}} , C} ) cos ( {θ}_{{v}_{{C}_{f}} , C} )} \qquad ( 26 )$$

For positive value of Pc, the second solution of (25) is used and the voltage reference that the filter capacitor in phase C must follow is defined by its magnitude and phase angle as:

$${V}_{c} = \sqrt{\frac{2 {P}_{c}}{{ω}_{s} {C}_{f}}} \qquad ( 27 )$$

$${θ}_{{v}_{{C}_{f}} , C} = atan ( \frac{- K \pm \sqrt{{K}^{2} + 4}}{2} ) \qquad ( 28 )$$

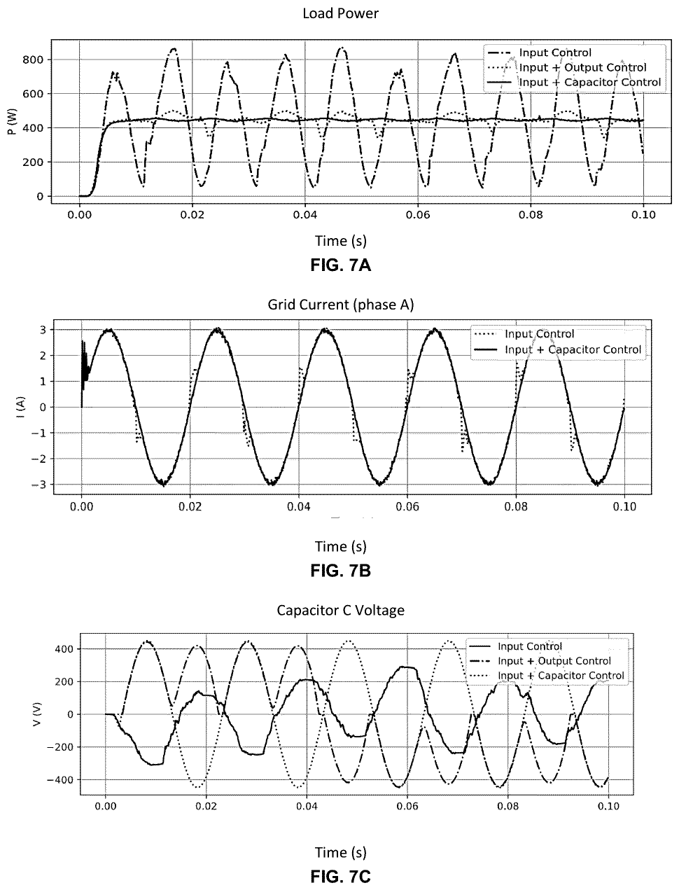

The MPC strategy will take into account these reference values during operation. Considering the capacitor voltage and the input current results in clear sinusoidal input currents and output power with negligible ripple as shown in FIGS. 7A-7C. Here, input control refers to the single-phase system with control of the input current only without decoupling. Input+Output control refers to the use of a decoupling capacitor but controlling only the input and output current. Last, the Input+Capacitor control regulates the voltage in the decoupling capacitor following the references in (27) and (28). The results achieved are superior to other techniques: the power ripple is eliminated while the grid currents and the capacitor voltages are both sinusoidal.

The following advantages can be realized with this third embodiment. In this embodiment, the input filter is a single-stage with a high-frequency zero which decreases the attenuation of high-frequency noise. However, it has the advantage of a reduced number of components and simplicity of the model to obtain the discretized state space equations used for the predictive control.

Regarding the resonant circuit, the distortion in the output current is affected by the quality factor of the resonant tank. In the parallel and series-resonant-parallel-loaded cases, the current circulating through the resonant components increases proportional to the load current by the quality factor. However, in the series resonant circuit selected for embodiment 1, the current through the tank is equal to the load current, independently of the quality factor. Hence, the components of the resonant circuit can be selected for lower current ratings and lower power will be dissipated in the parasitic resistances in the series case.

FIG. 8 shows a block diagram illustrating a power converter arrangement 800 for power conversion in a multi-phase power network in which at least one phase terminal is not operational according to a fourth embodiment.

In this fourth embodiment, the converter 800 can be operated with a three-phase input grid having a first phase terminal 211, a second phase terminal 212 and a third phase terminal 213. In this representation, the second phase and the third phase are not operational as indicated by the light grey lines. The switches of the power decoupling leg 138 can be used as the third phase leg switches. The input filter capacitors 240, 241, 242 can therefore play the role of the decoupling capacitor. The connection of the capacitors 240, 241, 242 can be either in Y (as shown here in FIG. 8) or Delta. The control algorithm can enable both single or three phase operation of the converter 800 by controlling or not the voltage across the capacitor 240 in phase C.

If the converter 800 is implemented to work both for single or three phase input, the secondary side of the converter can comprise two transformers and rectification stages, as shown in FIG. 9, which can be connected in series or in parallel depending on the load and voltage input. This way, two different voltage levels can be achieved. This can be useful to extend the operating voltage range of the converter.

FIGS. 10A-10C show different input filter topologies for the disclosed power converter arrangements. FIG. 10A shows a shunt R-C damping network as an exemplary, FIG. 10B shows a damping network comprising series damping R with parallel L, and FIG. 10C shows a damping network comprising a cascaded filter with parallel R-L damping in each section.

As illustrated in FIGS. 10A-10C, the topology of the input filter can be altered. A different filter architecture can be used to improve the performance of the converter regarding power factor and harmonics injection to the grid. The input filter capacitors can also be connected either in delta or star configuration. The different filter involves different equations for the application of the control strategy, but the derivation of these equations is equivalent to the one described above with respect to FIG. 3.

FIGS. 11A-11D show examples of possible resonant tank configurations with a) series, b) series parallel loaded, c) parallel, and d) LCC for the disclosed power converter arrangements.

The resonant circuit can be altered to a parallel or a series-parallel combined topology. Variation of the resonant circuit will result in modification of the equations to predict the value of the controlled variable at every sampling time, but the derivation of these equations is equivalent to the one described above with respect to FIG. 3.

FIG. 12 shows a circuit diagram of a transformer with integrated resonant tank for the disclosed power converter arrangements.

The resonant circuit can be integrated as part of the transformer by adjusting the parasitic capacitance and leakage inductance. Either one of the resonant components or both can be integrated into the transformer. In this case, the resonant circuit may not be visible, but the behavior of the system is identical. Therefore, the current or voltage at the matrix output will be sinusoidal and the switching events will occur at every zero-cross of this sinusoidal waveform. Each state of the matrix converter will be held during the same time.

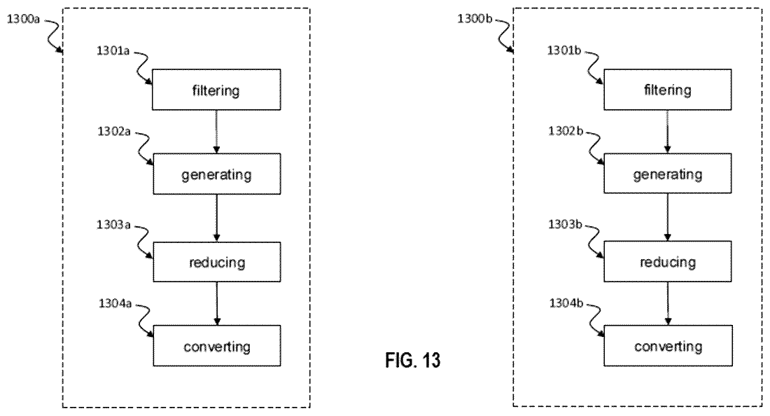

FIG. 13 shows a schematic diagram illustrating methods 1300a, 1300b for power conversion in a single-phase power network or in a multi-phase power network in which at least one phase terminal is not operational.

The method 1300a can be used for power conversion in a single-phase power network, e.g. as described above with respect to FIG. 1A. Such single-phase power network comprises a first phase terminal configured to provide a first AC voltage.

The method 1300a comprises filtering 1301a the first AC voltage 112 of the first phase terminal 111 of the single-phase power network to provide an input voltage 121.

The method 1300a comprises generating 1302a a switched voltage 151 from the input voltage 121 by an array of bidirectional switches 131 of an electrical switching network 130, wherein the switched voltage 151 is generated at an output terminal 145 of the switching network 130.

The method 1300a comprises reducing 1303a undesirable oscillations at the output terminal 145 by a decoupling capacitor 140 of the switching network 130.

The method 1300a comprises converting 1304a, by a resonant circuit 150, the switched voltage 151 into a supply voltage for supplying a load 160.

The method 1300b can be used for power conversion in a multi-phase power network, e.g., as described above with respect to FIG. 1B. Such multi-phase power network comprises a plurality of phase terminals 211, 212, 213, each phase terminal being configured to provide an AC voltage with a different voltage phase, wherein at least one phase terminal 212, 213 of the multi-phase power network is not operational.

The method 1300b comprises filtering 1301b, by an input filter 220, an AC voltage 112, 113, 114 received from a respective phase terminal 211, 212, 213 of the multi-phase power network to provide a respective input voltage 121, 122, 123.

The method 1300b comprises generating 1302b a switched voltage 151 from the respective input voltages 121, 122, 123 by an array of bidirectional switches 131 of an electrical switching network 130, wherein the switched voltage 151 is generated at an output terminal 145 of the switching network 130.

The method 1300b comprises reducing 1303b undesirable oscillations at the output terminal 145 by an input filter capacitor 240 of the input filter 120.

The method 1300b comprises converting 1304b, by a resonant circuit 150, the switched voltage 151 into a supply voltage for supplying a load 160.

The solution presented in this disclosure is suitable for any application where a single-stage AC/DC conversion may be needed and a double-line frequency ripple must be avoided at the output. Examples of these application scenarios are:
i) On-board and off-board chargers for electric vehicles (OBC).
ii) Uninterruptible Power Supply systems (UPS).
iii) Solid State Transformers (SST).

The solution presented in this disclosure enables the connection of the apparatus to either three-phase or single-phase grid input, keeping sinusoidal grid waveforms and constant output power in both operation modes.

The following benefits can be achieved:
1) Single-stage AC-DC conversion. No DC link is required, which translates in high compactness and power density.
2) Soft-switching at all times (ZCS) both in the matrix switches and the decoupling switches. The bidirectional switches are commuted when the current circulating through them is zero, which reduces switching losses, resulting in higher efficiency and lower thermal stress of the devices.
3) Compatibility with both single and three phase connection to the grid. This results in high flexibility of operation, which makes it suitable for applications as On-board chargers.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the present disclosure has been described with reference to one or more particular embodiments, those skilled in the art recognize that many changes may be made thereto without departing from the scope of the present disclosure. It is therefore to be understood that within the scope of the appended claims and their equivalents, the disclosure may be practiced otherwise than as specifically described herein.

1. A power converter arrangement comprising:
an input filter configured to couple to a first phase terminal of a single-phase power network, wherein the input filter is configured to:
receive a first alternating current (AC) voltage; and
filter the first AC voltage to provide an input voltage;
an electrical switching network comprising:
an output terminal;
an array of bidirectional switches configured to generate a switched voltage from the input voltage at the output terminal; and
a decoupling capacitor configured to reduce undesirable oscillations at the output terminal; and
a resonant circuit configured to convert the switched voltage into a supply voltage for supplying a load.

2. The power converter arrangement of claim 1, further comprising a controller configured to:
provide a switching signal to the array of bidirectional switches based on first electric measurements at the first phase terminal, second electric measurements of components of the input filter, third electric measurements across the resonant circuit, fourth electric measurements at an input of the electrical switching network, and a voltage measurement across the decoupling capacitor; and
control voltages and currents of the power converter arrangement to follow predefined reference values, wherein the voltages and the currents are associated with the first electric measurements, the third electric measurements, the fourth electric measurements, and the voltage measurement.

3. The power converter arrangement of claim 1, wherein the decoupling capacitor and the array of bidirectional switches are configured to reduce double line frequency harmonics from the single-phase power network operating at a line frequency.

4. The power converter arrangement of claim 2, wherein the controller is further configured to further provide the switching signal to switch the array of bidirectional switches during a zero crossing of the switched voltage or a zero-crossing of a corresponding current of the resonant circuit in order to reduce or eliminate switching losses of the array of switches.

5. The power converter arrangement of claim 1, wherein the electrical switching network further comprises a plurality of branches of bidirectional switches, wherein the branches are connected in parallel to form legs of the electrical switching network, and wherein the decoupling capacitor is connected to a midpoint of one of the legs of the electrical switching network.

6. The power converter arrangement of claim 5, wherein of the plurality of branches comprises a first branch connected to which the decoupling capacitor, and wherein the first branch forms a decoupling branch for decoupling the undesirable oscillations.

7. The power converter arrangement of claim 1, wherein the electrical switching network further comprises:
a first input node and a second input node each configured to receive the input voltage;
a first output node and a second output node each configured to provide the switched voltages;
a first branch of bidirectional switches and a second branch of bidirectional switches connected in parallel between the first output node and the second output node; and
a decoupling branch of bidirectional switches connected in parallel to the first branch and the second branch between the first output node and the second output node,
wherein the decoupling capacitor is connected to the decoupling branch.

8. The power converter arrangement of claim 7, wherein the first branch comprises:
a first intermediate node connected to the first input node; and
a first pair of bidirectional switches connected to the first intermediate node,
wherein the second branch comprises:
a second intermediate node connected to the second input node; and
a second pair of bidirectional switches connected to the second intermediate node,
wherein the decoupling branch comprises:
a third intermediate node; and
a third pair of bidirectional switches connected to the third intermediate node,
wherein the decoupling capacitor is connected between the third intermediate node and a ground terminal.

9. A power converter arrangement comprising:
an input filter comprising a first input filter capacitor, wherein the input filter is configured to:
couple to a plurality of phase terminals of a multi-phase power network to receive a respective alternating current (AC) voltage, wherein each of the phase terminals is configured to provide the AC voltage with a different voltage phase, wherein at least one phase terminal of the multi-phase power network is a non-operational phase terminal; and
filter the respective AC voltage to provide a respective input voltage;
an electrical switching network comprising:
an output terminal, wherein the first input filter capacitor is configured to reduce undesirable oscillations at the output terminal; and
an array of bidirectional switches configured to generate a switched voltage from the respective input voltages at the output terminal; and
a resonant circuit configured to convert the switched voltage into a supply voltage for supplying a load.

10. The power converter arrangement of claim 9, further comprising a controller to configured to:
provide a switching signal to the array of bidirectional switches based on first electric measurements at at least one of the phase terminals, second electric measurements of components of the input filter, third electric measurements across the resonant circuit, a fourth measurement of the input voltages at an input of the electrical switching network, and a fifth voltage measurement across the first input filter capacitor; and
control voltages and currents of the power converter arrangement to follow predefined reference values, wherein the voltages and the currents are associated with the first electric measurements, the third electric measurements, the fourth measurement, and the fifth voltage measurement.

11. The power converter arrangement of claim 9, wherein during a disconnected phase, the first input filter capacitor is further configured to reduce double line frequency harmonics from the non-operational phase terminal of the multi-phase power network operating at a line frequency.

12. The power converter arrangement of claim 9, wherein the input filter comprises input filter capacitors, wherein the input filter capacitors comprise the first input filter capacitor, and wherein the input filter capacitors are configured to couple to the phase terminals.

13. The power converter arrangement-(200) of claim 12, wherein the input filter capacitors are interconnected in a Y-configuration or in a Delta-configuration.

14. The power converter arrangement of claim 2, wherein the controller is further configured to:
determine deviations of the first electric measurements, the third electric measurements, the fourth electric measurements, and the voltage measurement from their reference values; and
determine the switching signal based on a cost function of the deviations.

15. The power converter arrangement of claim 14, wherein the controller is further configured to determine a configuration of the array of bidirectional switches that minimizes the cost function while providing the switching signal.

16. The power converter arrangement of claim 2, wherein the controller is further configured to determine the predefined reference values based upon a balance of a power of the single-phase power network with respect to a power at the load, a power across the decoupling capacitor, a power in the input filter, and a loss power.

17. The power converter arrangement of claim 10, wherein the controller is further configured to determine the predefined reference values based upon a balance of a power of the multi-phase power network with respect to a power at the load, a power across the first input filter capacitor, a power in the input filter and a loss power.

18. The power converter arrangement of claim 16, wherein the controller is further configured to determine at least one of the power, the voltage and/or, or a current across the decoupling capacitor in order to force the power at the load to be constant.

19. A method comprising:
filtering a first alternating current (AC) voltage of a first phase terminal of a single-phase power network in order to provide an input voltage;
generating, at an output terminal of an electrical switching network, a switched voltage from the input voltage using an array of bidirectional switches of the electrical switching network;
reducing undesirable oscillations at the output terminal using a decoupling capacitor of the electrical switching network; and
converting, by a resonant circuit, the switched voltage into a supply voltage for supplying a load.

20. A method comprising:
filtering, by an input filter, alternating current (AC) voltages from a plurality of phase terminals of a multi-phase power network in order to provide a-respective input voltages;
generating, at an output terminal of an electrical switching network, a switched voltage from the respective input voltages using an array of bidirectional switches of the electrical switching network;
reducing undesirable oscillations at the output terminal by using an input filter capacitor of the input filter; and
converting, by a resonant circuit, the switched voltage into a supply voltage for supplying a load.
